(19) United States
(12) Patent Application Publication
(10) Pub. No.: US 2011/0295744 A1
(43) Pub. Date: Dec. 1, 2011

(54) GIFT CARD PROCESSING

(76) Inventors: Mark Lloyd Wisniewski, Salt Lake City, UT (US); Solim Gasparik, Park City, UT (US)

(21) Appl. No.: 12/790,053

(22) Filed: May 28, 2010

(51) Int. Cl. G06Q 40/00

(52) U.S. Cl. 705/41

(57) ABSTRACT

The present invention extends to methods, systems, and computer program products for processing gift cards. Some embodiments permit a user to aggregate value from a plurality of merchant specific gift cards onto a universal gift card useable at a variety of merchants. Embodiments also facilitate ignoring and/or adding restrictions from merchant specific gift cards when values are aggregated. Unused balances from universal card accounts can be transferred to an interest bearing account for the benefit of a universal card management system. In other separate embodiments, characteristics of a plurality of other types of cards, such as, rewards cards, are aggregated under a user card account.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

Due to computer networks, and especially the Internet, electronic or “online” purchases have steadily increased. For example, consumers can easily use a debit card, credit card, or pre-funded accounts (e.g., paypal) to purchase items online. This provides a high level of convenience for a consumer, eliminating the need for the consumer to travel. Many card companies also sell general purpose “pre-denominated” cards that function as a debit card until their balance is exhausted.

The use of a number of merchant specific forms of payment, such as, for example, gift cards and stored value cards have also increased. Each month, hundreds of millions of dollars worth of transactions are generated at various retailer points of sale (both electronic and in “brick and mortar” locations) using merchant specific forms of payment. Merchant specific gift cards can be activated at a point of sale in pre-denominated amounts for use at a specific merchant.

Gift cards are often given as gifts, permitting the recipient of the gift card to purchase an item they desire from a specified merchant. For a variety of reasons, many gift cards go unredeemed. For example, a recipient may have no interest in any items at a specified merchant, a recipient may fail to use a gift card before its expiration date, or a recipient may lose a gift card.

Some online systems permit the buying selling, and trading of gift cards. This permits users to exchange gift cards amongst one another to obtain a gift card redeemable at a merchant of interest. However, these gift card trading systems make it difficult to place precise value on cards. These trading systems may also fail to have and/or not accept cards from specified merchants of interest. Thus, even if a consumer desired to exchange a gift card, they may not be able to and/or there may be nothing of interest for the consumer to obtain in return.

### BRIEF SUMMARY

The present invention extends to methods, systems, and computer program products for gift card processing. Embodiments of the invention aggregate the balance of one or more merchant gift cards to the balance of a universal gift card. A universal gift card management system receives a request to credit a universal gift card from funds on a merchant gift card. The merchant gift card is issued by a specified merchant and has a balance of a specified amount of funds redeemable at the specified merchant.

In response to the request, a portion of the balance of funds on the merchant gift card is credited to the universal gift card. Crediting the universal gift card makes the portion of the balance of the merchant gift card available for use at any participating merchant configured to interact with the universal gift card management system, essentially universalizing the portion of the balance of funds credited to the universal gift card. Control of the merchant gift card is transferred to the universal gift card management system. Accordingly, further use of the merchant gift card by other entities is prevented.

Subsequently, the universal gift card management system participates in a transaction with a specified merchant to permit the specified merchant to buy back the merchant gift card from the universal gift card management system. The transaction includes transferring control of the merchant gift card back to the specified merchant. The transaction also includes receiving a further amount of funds from the specified merchant in exchange for transferring control of the merchant gift card back to the specified merchant.

Portions of the balance of other merchant specific cards can be aggregated to the balance of the universal gift card in a similar manner to further increase the balance of the universal gift card. The owner of the universal gift card can then use the aggregated balance to purchase an item from a participating merchant. An amount of funds can be transferred from the universal gift card to a merchant. The amount of funds can include funds from plurality of different merchant specific gift cards. The owner can receive an item from the merchant in response to transferring the amount of funds.

In some embodiments, terms associated with gift cards can also be managed. A request to credit a universal gift card from funds on a merchant gift card is received. The merchant gift card has one or more characteristics (e.g., expiration date, product blocking, etc.) defining the terms of use of the merchant gift card. One or more characteristics of the universal gift card are adjusted. Adjusting characteristics of the universal gift card can be based on the one or more characteristics of the merchant gift card. Adjustment can include ignoring a characteristic of the merchant gift card (e.g., to remove a restriction on the terms of usage of the merchant gift card from the universal gift card). Adjustment can also include adding a characteristic to the universal gift card (e.g., to add a restriction the terms of use of the universal gift card).

In other embodiments, unused balance from a plurality of universal gift cards is used for the benefit of the universal card management system. A plurality of universal gift cards are credited by various different amounts. Unused balances across the plurality of gifts cards within the universal card management system are calculated. A portion of the amount of unused balances is transferred into an interest bearing account for the benefit of the universal gift card management system and/or one or more participating merchants. The amount of unused balances plus an additional amount of funds from the interest bearing account is received subsequent to transferring the portion of the amount of unused balances into the interest bearing account. The additional amount of funds is maintained in an account for the benefit of the universal gift card management system.

In additional separate embodiments, characteristics associated with a universal card are managed. A first request to aggregate first characteristics of a first specified card onto a universal card is received. The first characteristics define the terms of use of the first specified card for a first entity, including an entity identifier for the first entity. A second request to aggregate second characteristics of a second different specified card onto the universal card is received. The second characteristics define the terms of use of the second specified card for a second entity, including an entity identifier for the second entity. In response to the first request and the second request, the characteristics of the universal card are adjusted to collectively represent the first characteristics and second characteristics under an identifier for the universal card.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A-1C illustrate an example computer architecture that facilitates gift card processing

FIG. 2 illustrates a flow chart of an example method for aggregating the balance of one or more merchant gift cards to the balance of a universal gift card.

FIG. 3 illustrates a flow chart of an example method for managing terms of use for gift cards.

FIG. 4 illustrates a flow chart of an example method for crediting funds to the universal gift card management system.

FIG. 5 illustrates an example computer architecture that facilitates combining characteristics of different cards onto a universal card.

FIG. 6 illustrates a flow chart of an example method for combining characteristics of different cards onto a universal card.

### DETAILED DESCRIPTION

The present invention extends to methods, systems, and computer program products for gift card processing. Embodiments of the invention aggregate the balance of one or more merchant gift cards to the balance of a universal gift card. A universal gift card management system receives a request to credit a universal gift card from funds on a merchant gift card. The merchant gift card is issued by a specified merchant and has a balance of a specified amount of funds redeemable at the specified merchant.

In response to the request, a portion of the balance of funds on the merchant gift card is credited to the universal gift card. Crediting the universal gift card makes the portion of the balance of the merchant gift card available for use at any participating merchant configured to interact with the universal gift card management system, essentially universalizing the portion of the balance of funds credited to the universal gift card. Control of the merchant gift card is transferred to the universal gift card management system. Accordingly, further use of the merchant gift card by other entities is prevented.

Subsequently, the universal gift card management system participates in a transaction with a specified merchant to permit the specified merchant to buy back the merchant gift card from the universal gift card management system. The transaction includes transferring control of the merchant gift card back to the specified merchant. The transaction also includes receiving a further amount of funds from the specified merchant in exchange for transferring control of the merchant gift card back to the specified merchant.

Portions of the balance of other merchant specific cards can be aggregated to the balance of the universal gift card in a similar manner to further increase the balance of the universal gift card. The owner of the universal gift card can then use the aggregated balance to purchase an item from a participating merchant. An amount of funds can be transferred from the universal gift card to a merchant. The amount of funds can include funds from plurality of different merchant specific gift cards. The owner can receive an item from the merchant in response to transferring the amount of funds.

In some embodiments, terms associated with gift cards can also be managed. A request to credit a universal gift card from funds on a merchant gift card is received. The merchant gift card has one or more characteristics (e.g., expiration date, product blocking, etc.) defining the terms of use of the merchant gift card. One or more characteristics of the universal gift card are adjusted. Adjusting characteristics of the universal gift card can be based on the one or more characteristics of the merchant gift card. Adjustment can include ignoring a characteristic of the merchant gift card (e.g., to remove a restriction on the terms of usage of the merchant gift card from the universal gift card). Adjustment can also include adding a characteristic to the universal gift card (e.g., to add a restriction the terms of use of the universal gift card).

In other embodiments, unused balance from a plurality of universal gift cards is used for the benefit of the universal card management system. A plurality of universal gift cards are credited by various different amounts. Unused balances across the plurality of gifts cards within the universal card management system are calculated. A portion of the amount of unused balances is transferred into an interest bearing account for the benefit of the universal gift card management system and/or one or more participating merchants. The amount of unused balances plus an additional amount of funds from the interest bearing account is received subsequent to transferring the portion of the amount of unused balances into the interest bearing account. The additional amount of funds is maintained in an account for the benefit of the universal gift card management system.

In additional separate embodiments, characteristics associated with a universal card are managed. A first request to aggregate first characteristics of a first specified card onto a universal card is received. The first characteristics define the terms of use of the first specified card for a first entity, including an entity identifier for the first entity. A second request to aggregate second characteristics of a second different specified card onto the universal card is received. The second characteristics define the terms of use of the second specified card for a second entity, including an entity identifier for the second entity. In response to the first request and the second request, the characteristics of the universal card are adjusted to collectively represent the first characteristics and second characteristics under an identifier for the universal card.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

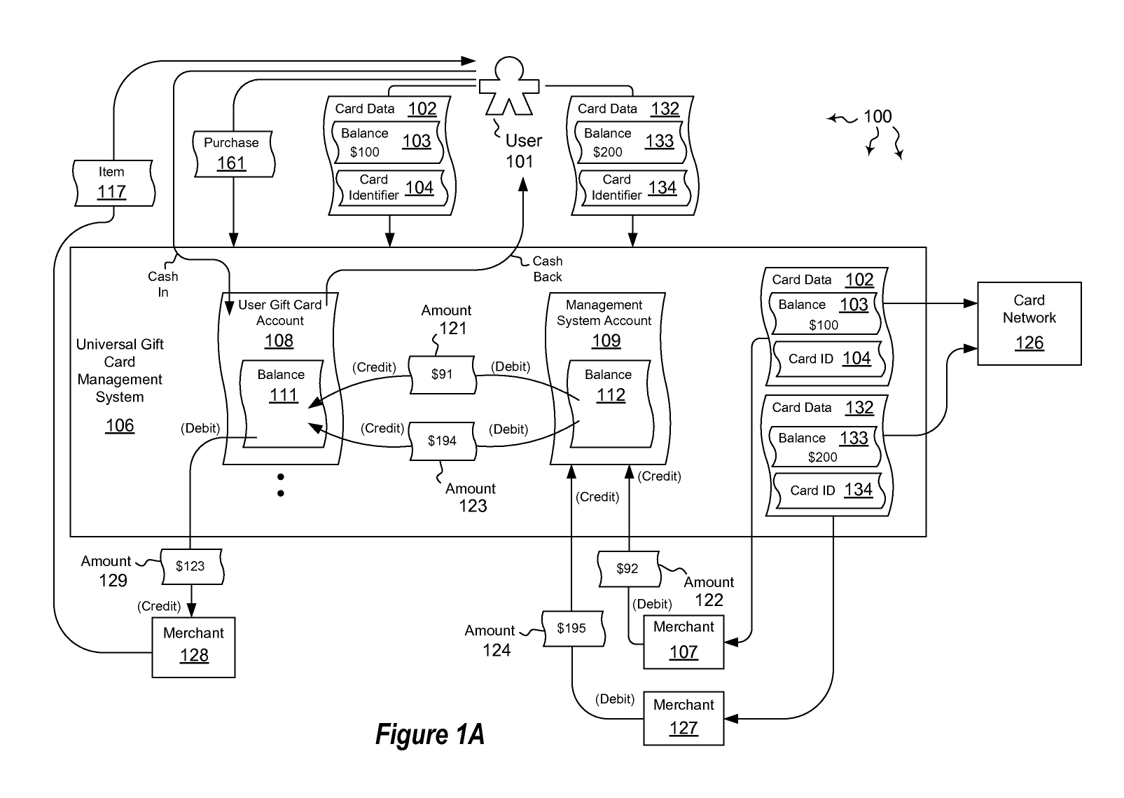

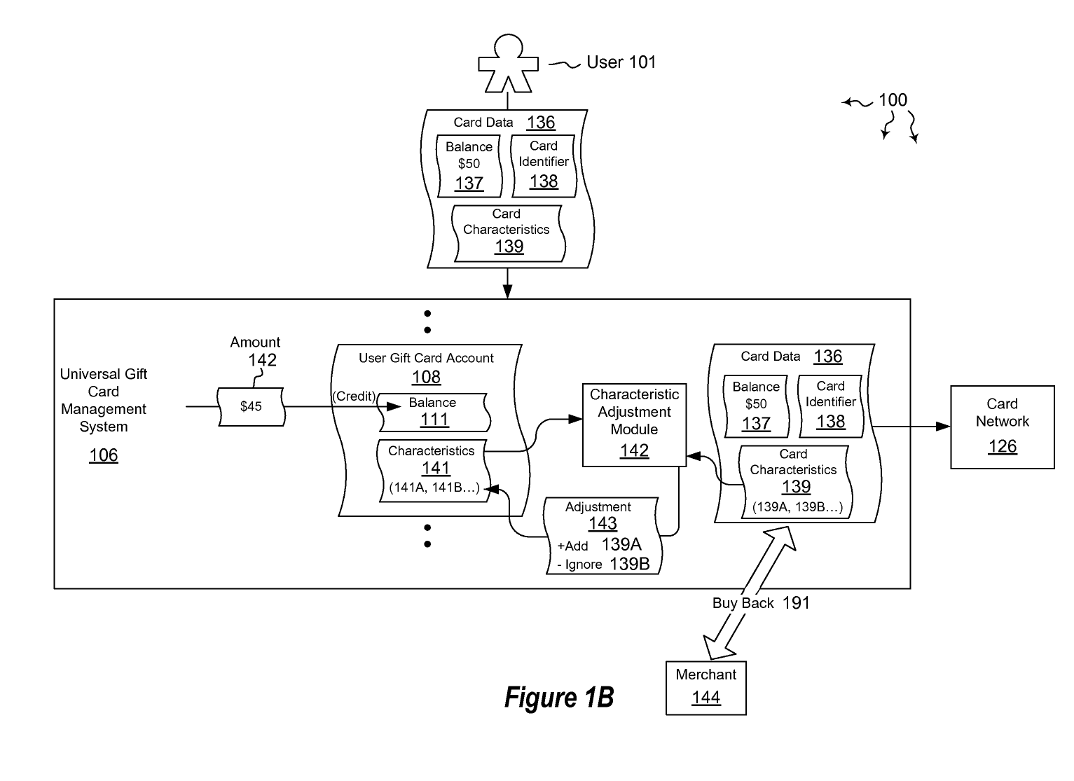

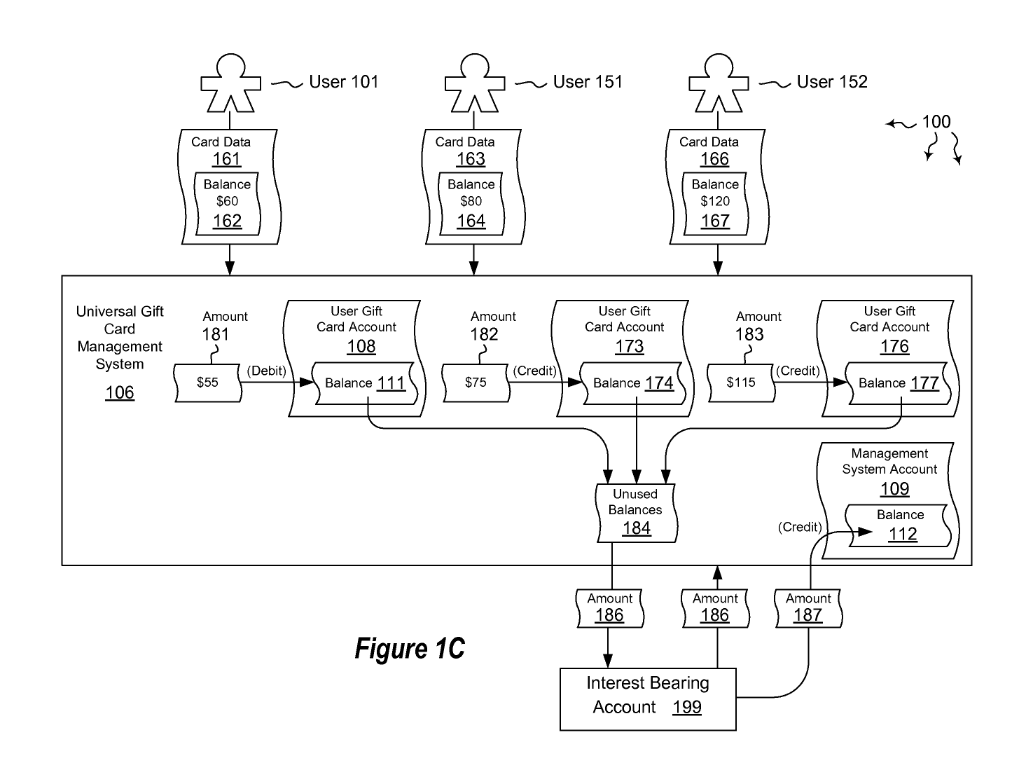

FIG. 1A-1C illustrate an example computer architecture 100 that facilitates gift card processing. Referring to FIG. 1, computer architecture 100 includes user 101, universal gift card management system 106, card network 126, and merchants 107, 127, and 128. Each of the depicted components is connected to one another over (or is part of) a network, such as, for example, a Local Area Network (“LAN”), a Wide Area Network (“WAN”), and even the Internet. Accordingly, each of the components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Generally, universal gift card management system 106 is used to manage universal gift cards for account holders of universal gift cards. Universal gift card management system can be used to credit and debit universal gift card accounts, manage the terms of use of gift cards, and credit funds to the universal gift card system. Account holders, such as, for example, user 101, can log into universal gift card management system 106 to access their account details, credit funds from merchant specific gift cards to their account, credit their account in other ways, transfer funds to other accounts, and make purchases from their account.

Universal gift card management system 106 can interact with card network 126 (e.g., a gift card network) to take control of merchant specific gift cards present by account holders. Universal gift card management system 106 can indicate ownership of merchant specific gift cards to card network 126 such that merchant specific gift cards are invalidated for user by others.

Universal gift card management system 106 can also interact with merchants to permit merchants to buy back merchant specific gift cards.

In some embodiments, universal gift card management system 106 essentially buys merchant specific gift cards from account holders and credits their accounts by some portion of the balance on the merchant specific gift cards. Universal gift card management system 106 can credit a universal gift card account by the entire balance or some portion of the balance on a merchant specific gift card. For example, universal gift card management system 106 can take control of a merchant specific gift card having a value of $100.00 and credit a user gift card account by $95.

Universal gift card management system 106 can also permit an issuing merchant to buy back a merchant specific gift card. In some embodiments, universal gift card management system 106 permits a merchant to buy back an issued gift card for less than the balance on the gift card. Thus, the merchant is provided some financial benefit when buying back a gift card they issued. For example, a merchant may be able to take possession of a $100.00 gift card by buying the gift card for $96.00 (or some other amount) from universal gift card system 106.

The buy back amount can be the same as the amount credited to a user gift card account. For example, universal gift card management system 106 can buy a gift card with a $50 balance for $45 and then sell the gift card to the issuing merchant for $45. Alternately, the buy back amount can be more than the amount credited to a user gift card account but less than the balance on the gift card. For example, universal gift card management system 106 can buy a gift card having a $100 balance for $95 and then sell the gift card to the issuing merchant for $96. Thus, in some embodiments, universal gift card management system 106 is also provided a financial benefit.

Universal gift card management system 106 can also accept cash, such as, for example, received via an electronic funds transfer, and credit a universal gift card amount by the entire amount or some portion of the amount of cash received.

Funds in a user gift card account can be used at any participating merchant in a group of merchants configured to accept funds linked to universal gift card management system 106. Thus, in exchange for selling a merchant specific gift card (even for less than full value), an account holder is credited with funds that can be used at a wider variety of merchants.

Universal gift card management system can also provide accounts holders with cash back. For example, universal gift card management system can return some portion of amount 121 ($91) to user 101 after taking control of card data 102.

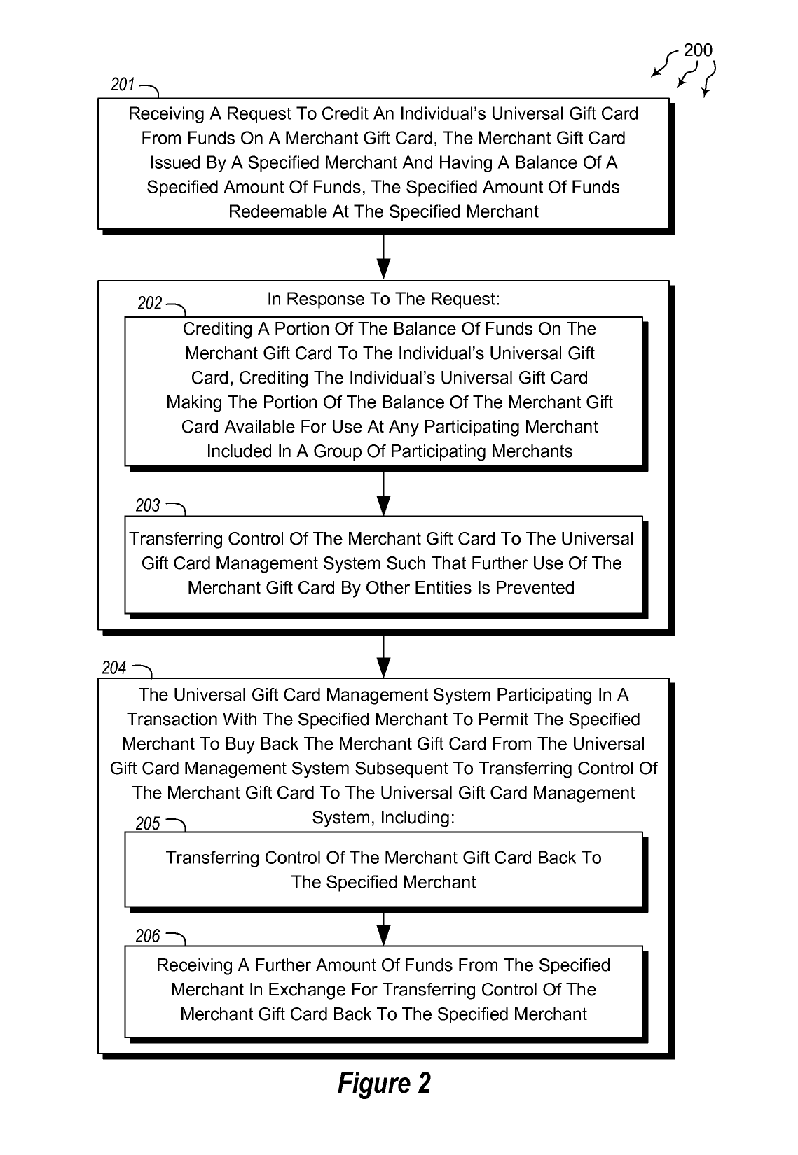

FIG. 2 illustrates a flow chart of an example method for aggregating the balance of one or more merchant gift cards to the balance of a universal gift card. FIG. 2 will be described with respect to the components and data in FIG. 1A.

Method 200 includes an act of receiving a request to credit an individual's universal gift card from funds on a merchant gift card, the merchant gift card issued by a specified merchant and having a balance of a specified amount of funds, the specified amount of funds redeemable at the specified merchant (act 201). For example, universal gift card management system 106 can receive card data 102 from user 101. Card data 102 can contain electronic data, for example, card identifier 104, representing a merchant specific gift card issued by merchant 107. As such, balance 103 ($100) is redeemable at merchant 107. User 101 can have user gift card account 108 with universal gift card management system 106.

Method 200 includes in response to the request, an act of the crediting a portion of the balance of funds on the merchant gift card to the individual's universal gift card, crediting the individual's universal gift card making the portion of the balance of the merchant gift card available for use at any participating merchants included in a group of merchants (act 202). For example, universal gift card management system 106 can credit amount 121 ($91) to balance 111 (thus debiting amount 121 from balance 112). Thus, amount 121 is available for use at any participating merchant included in a group of participating merchants configured to accept funds from universal gift card management system 106. Making amount 121 available for more generalized use essentially universalizes amount 121.

Generally an amount credited to a user gift card account can be some percentage (e.g., 95%) of the balance of a merchant specific gift card and/or can be the balance of the merchant specific gift card minus a fee (e.g., $5).

Method 200 also includes in response to the request, an act of transferring control of the merchant gift card to the universal gift card management system such that further use of the merchant gift card by other entities is prevented (act 203). For example, universal gift card management system 106 can submit card data 102 to card network 126. In response to receiving card data 102, card network 126 can invalidate card data 102 for further use. Various security rules and procedures can be used to insure control of card data 102 is appropriately transferred (e.g., from user 101) to universal gift card management system 106.

Method 200 includes an act of the universal gift card management system participating in a transaction with the specified merchant to permit the specified merchant to buy back the merchant gift card from the universal gift card management system subsequent to transferring control of the merchant gift card to the universal gift card management system (act 204). For example, gift card management system 106 can participate in a transaction with merchant 107 to permit merchant 107 to buy back the gift card represented by card data 102. As part of the buyback procedure, merchant 107 can verify the authenticity and ownership of card data 102.

Act 204 can include an act of transferring control of the merchant gift card back to the specified merchant (act 205). For example, control of card data 102 can be transferred to merchant 107. Various security rules and procedures can again be used to insure control of card data 102 is appropriately transferred (e.g., from universal gift card management system 106) to merchant 107. Act 204 can include an act of receiving a further amount of funds from the specified merchant in exchange for transferring control of the merchant gift card back to the specified merchant (act 206). For example, universal gift card management system 106 can receive amount 122 ($92) from merchant 107.

Subsequently, universal gift card management system 106 can receive card data 102 from user 101. Card data 132 can contain electronic data, such as, for example, card identifier 134, representing a merchant specific gift card issued by merchant 127. As such, balance 133 ($200) is redeemable at merchant 127. In response to receiving card data 132, universal gift card management system 106 can credit amount 123 ($194) to balance 111 (thus debiting amount 123 from balance 112). As such, amount 131 is now also available for use at any participating merchant included in a group of merchants configured to accept funds from universal gift card management system 106.

Universal gift card management system 106 can submit card data 132 to card network 126. In response to receiving card data 132, card network 126 can invalidate card data 132 for further use. Various security rules and procedures can be used to insure control of card data 132 is appropriately transferred (e.g., from user 101) to universal gift card management system 106.

Universal gift card management system 106 can then participate in a transaction with merchant 127 to permit merchant 127 to buy back the gift card represented by card data 132. As such, control of card data 132 can be transferred to merchant 127. Various security rules and procedures can again be used to insure control of card data 132 is appropriately transferred (e.g., from universal gift card management system 106) to merchant 127. Universal gift card management system 106 can receive amount 124 ($195) from merchant 127.

Accordingly, funds from a merchant specific gift card issued by merchant 107 and funds from a merchant specific gift card issued by merchant 127 are aggregated in user gift card account 108. The aggregated funds can be used to purchase items at any participating merchants in a group of merchants configured to accept funds from universal gift card management system 106.

Thus, user 101 can submit purchase 161 to universal gift card management system 106. Purchase 161 can represent purchasing an item from merchant 128. In response to purchase 161, universal gift card management system 106 can transfer amount 129 ($123) to merchant 128. Amount 129 can thus include a portion of funds from balance 103 and a portion of funds from balance 133. In response to the transfer of funds, merchant 128 can return item 117 (e.g., a physical item or electronic content) to user 101. User 101 can receive item 117 from merchant 128.

In some embodiments, funds are transferred using electronic funds transfers (EFTs) such that transferred funds available to a recipient in essentially real-time. Merchants 107 and 127 may or may not be participating merchants along with merchant 128.

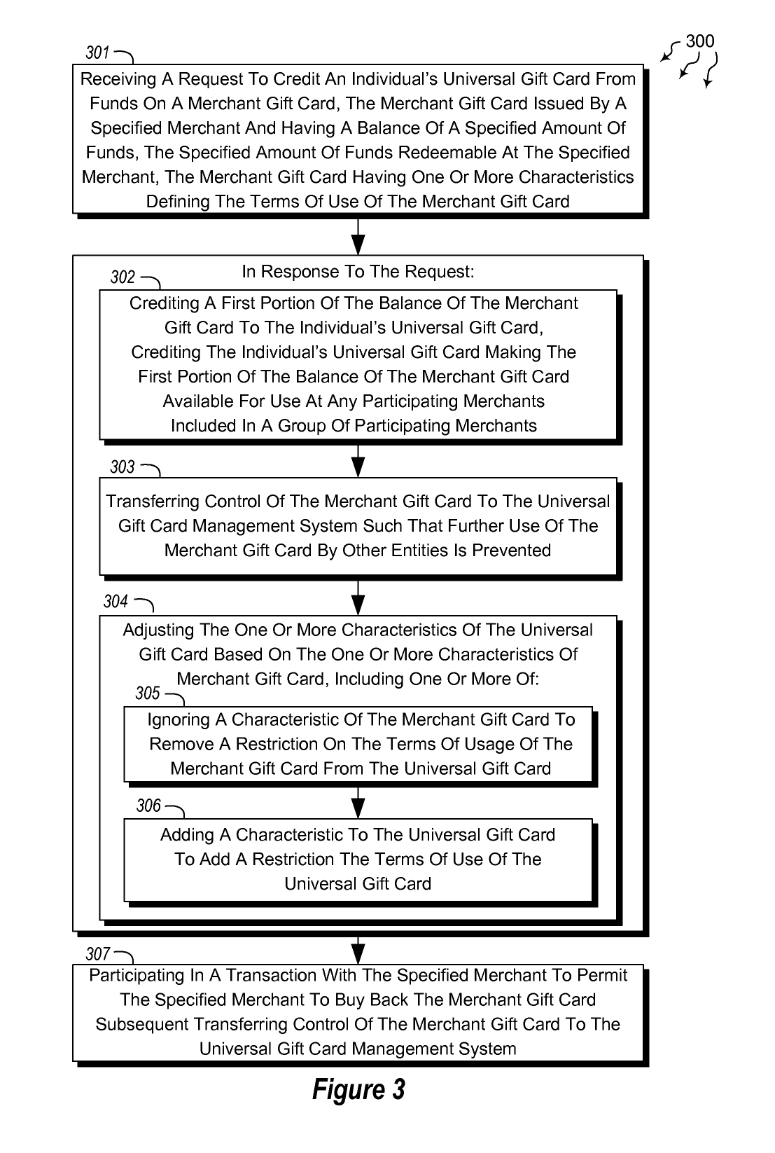

FIG. 3 illustrates a flow chart of an example method 300 for managing terms of use for gift cards. Method 300 will be described with respect to the components and data in FIG. 1B.

Method 300 includes an act of receiving a request to credit an individual's universal gift card from funds on a merchant gift card, the merchant gift card issued by a specified merchant and having a balance of a specified amount of funds, the specified amount of funds redeemable at the specified merchant, the merchant gift card having one or more characteristics defining the terms of use of the merchant gift card (act 301). For example, universal gift card management system 106 can receive card data 136 from user 101. Card data 136 can contain electronic data, such as, for example, card identifier 138, representing a merchant specific gift card issued by merchant 144. As such, balance 137 ($50) is redeemable at merchant 144. Card characteristics 139 define the terms of use of the merchant specific gift card. Terms of use can include an expiration date, mechanisms for preventing or limiting use of balance 137 for the purchase of specific items, etc. Prevent or limiting use can be done through Universal Product Code (“UPC”) blocking or other similar mechanisms. Different individual card characteristics 139A, 139B, etc., can be used to represent different portions of the terms of user for the merchant specific gift card.

Method 300 includes in response to the request, an act of crediting a first portion of the balance of the merchant gift card to the individual's universal gift card, crediting the individual's universal gift card making the first portion of the balance of the merchant gift card available for use at one or more participating merchants included in a group of participating merchants (act 302). For example, universal gift card management system 106 can credit amount 142 ($45) to balance 111 (thus debiting amount 121 from balance 112). Thus, amount 142 is available for use at any participating merchant included in a group of merchants configured to accept funds from universal gift card management system 106.

Method 300 includes in response to the request, an act of transferring control of the merchant gift card to the universal gift card management system such that further use of the merchant gift card by other entities is prevented (act 303). For example, universal gift card management system 106 can submit card data 136 to card network 126. In response to receiving card data 136, card network 126 can invalidate card data 136 for further use. Various security rules and procedures can be used to insure control of card data 136 is appropriately transferred (e.g., from user 101) to universal gift card management system 106.

Method 300 includes an act of adjusting the one or more characteristics of the universal gift card based on the one or more characteristics of merchant gift card (act 304). For example, characteristics 141 can be adjusted based on characteristics 139. Characteristic adjustment module 142 can access both card characteristics 139 and characteristics 141. Characteristic adjustment module 142 can formulate adjustment 143 based on card characteristics 139 and characteristics 141.

Act 304 can include ignoring a characteristic of the merchant gift card to remove a restriction on the terms of usage of the merchant gift card from the universal gift card (act 305). For example, adjustment 143 can instruct universal gift card management system 106 to ignore a restriction on the terms of use of the merchant specific gift card represented card characteristics 139. In one embodiment, adjustment 143 instructs universal gift card management system 106 to ignore characteristic 139B (e.g., an expiration date) on the use of funds from balance 137.

Act 304 can also include an act of adding a characteristic to the universal gift card to add a restriction the terms of use of the universal gift card (act 306). For example, adjustment 143 can instruct universal gift card management system 106 to add a restriction to the terms of use of user gift card account 108. In one embodiment, adjustment 143 instructs universal gift card management system 106 to add characteristic 139A (e.g., UPC blocking) to the use of funds from balance 137 (or even all of balance 111).

Method 300 includes an act of participating in a transaction with the specified merchant to permit the specified merchant to buy back the merchant gift card subsequent transferring control of the merchant gift card to the universal gift card management system (act 306). For example, universal gift card management system 106 and merchant 144 can participate in buy back 191 to permit merchant 141 to buy back the merchant specific gift card represented by card data 136. Card network 126 can be used as appropriate to transfer control of card data 136.

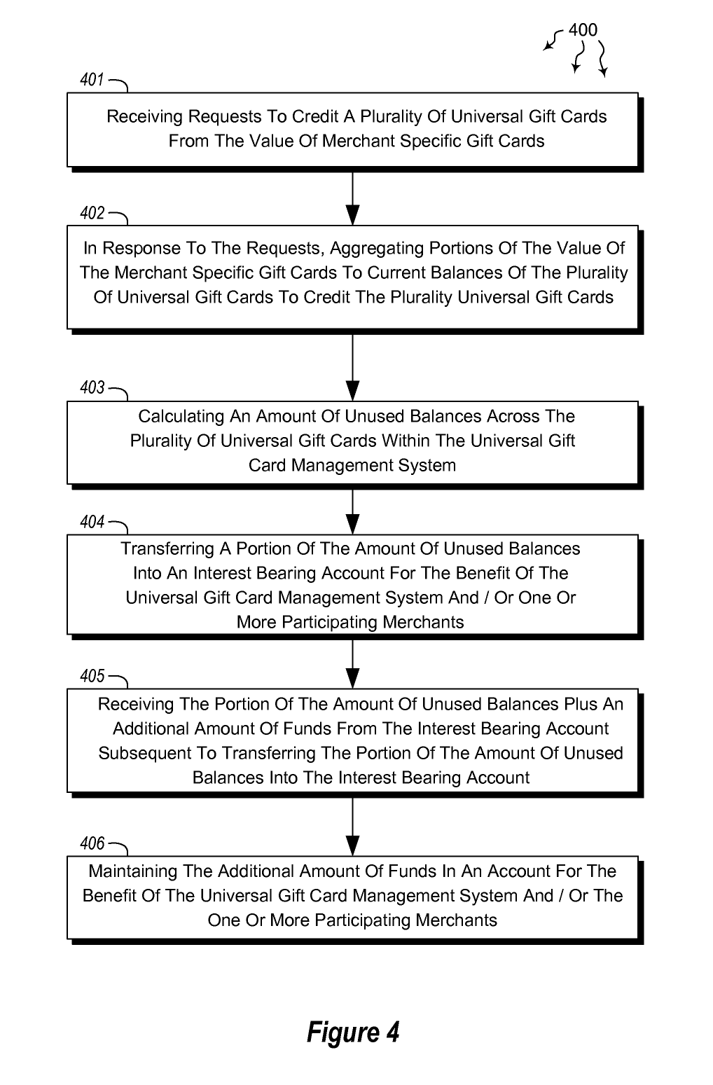

FIG. 4 illustrates a flow chart of an example method for crediting funds to the universal gift card management system. Method 400 will be described with respect to the components and data in FIG. 1C.

As depicted in FIG. 1C, universal gift card management system 106 can manage user gift accounts for a plurality of users. For example, universal gift card management system 106 can manage user gift card accounts 108, 173, and 176 for users 101, 151 and 152 respectively. Each user account can have a balance that is available to a user for use at any merchants in a group of merchants configured to accept funds from universal gift card management system 106. For example, user gift card accounts 108, 173, and 176 have balances 111, 174, and 177 respectively.

Method 400 includes an act of receiving requests to credit a plurality of universal gift cards from the value of merchant specific gift cards (act 401). For example, universal gift card management system 106 can receive card data 161, 163, and 166 representing requests to credit balances 111, 174, and 177 respectively. Amounts 162 ($60), 164 ($80), and 167 ($120) can represent the value of merchants specific gift cards for one or more merchants.

Method 400 includes in response to the requests an act of aggregating portions of the value of the merchant specific gift cards to current balances of the plurality of universal gift cards to credit the plurality universal gift cards (act 402). For example, universal gift card management system 106 can credit balances 111, 174, and 177 by amounts 181 ($55), 182 ($75), and 183 ($115) respectively.

Method 400 includes calculating an amount of unused balances across the plurality of universal gift cards within the universal gift card management system (act 403). For example, universal gift card management system 106 can calculate unused balances 184 across some or all of user gift card accounts managed by universal gift card management system 106 (e.g., including balances 111, 174, and 177). An unused amount can be an amount in a user gift card account at a specified time of day. An unused amount can also be some percentage of the overall balance of a user gift card account. For example, 10% of the balance of each user gift card account.

Method 400 includes an act of transferring a portion of the amount of unused balances into an interest bearing account for the benefit of the universal gift card management system and/or one or more participating merchants (act 404). For example, universal gift card management system 106 can transfer amount 186 to interest bearing account 199. Interest bearing account 199 can be a sweep account or other type of interest bearing account.

Method 400 includes an act of receiving the portion of the amount of unused balances plus an additional amount of funds from the interest bearing account subsequent to transferring the portion of the amount of unused balances into the interest bearing account (act 405). For example, universal gift card management system 106 can receive back amount 186 plus amount 187. Amount 187 represents the interest earned on amount 186 over a specified period of time (e.g., overnight).

Method 400 includes an act of maintaining the additional amount of funds in an account for the benefit of the universal gift card management system and/or the one or more participating merchants (act 406). For example, a portion of amount 187 can be credited to balance 112 for the benefit of universal gift card management system 106. When appropriate, other portions amount 187 can be transferred to the one or more participating merchants. Portions of amount 186 can be credited back to user gift card accounts balances (including balances 111, 174, and 177) as appropriate to credit account balances that were debited when calculating unused balances 184.

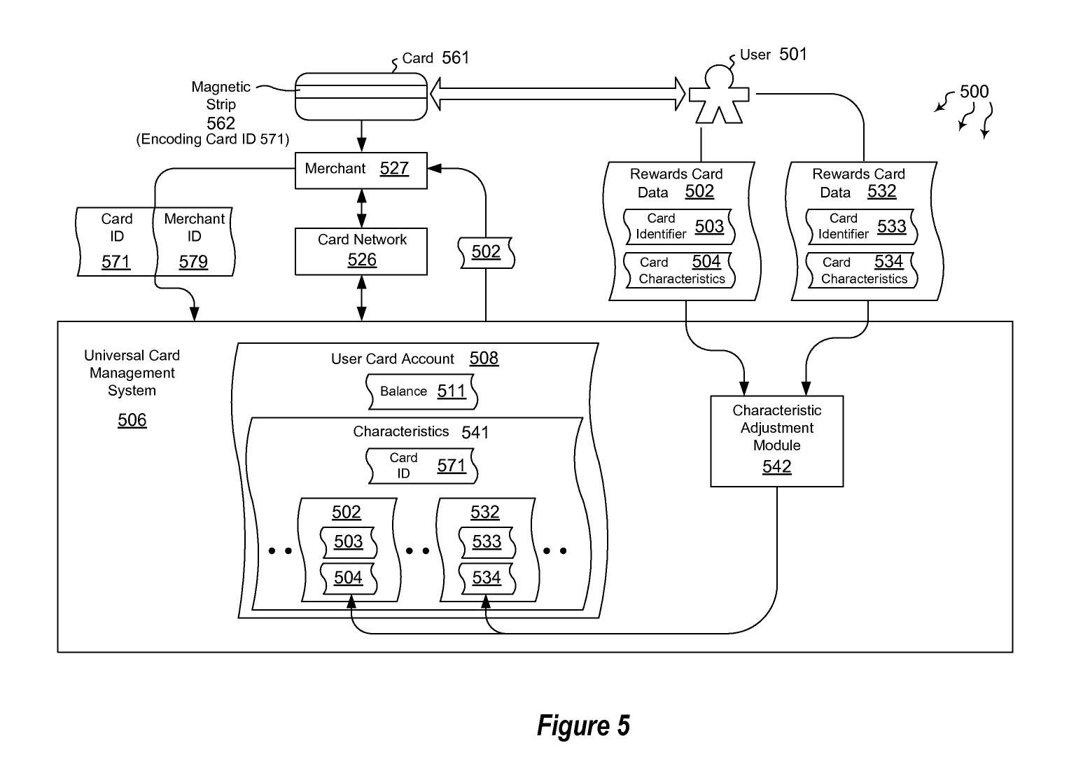

In additional separate embodiments of the invention, characteristics associated with a universal card are managed. FIG. 5 illustrates an example computer architecture 500 that facilitates combining characteristics of different cards onto a universal card. As depicted, FIG. 5 includes user 501, universal card management system 506, merchant 527, and card network 526. Universal card management system 506 further includes characteristic adjustment module 542. The components in computer architecture can be connected to one another over a network similar to the components in computer architecture 100.

Characteristic adjustment module 542 is configured to combine the characteristics of a plurality of other cards onto a universal card. Other cards can include but are not limited to: a rewards card, a membership card, a savings card, a club card, a preferred card, a mileage card, a loyalty card, a V.I.P. card, a discount card, a coupon card, an activity card, an I.D., a season pass, an annual pass, and a program pass. Combined characteristics for a plurality other cards can be stored under the identifier for a universal card. As such, the characteristics of the plurality of other cards can be access through reference to the universal card.

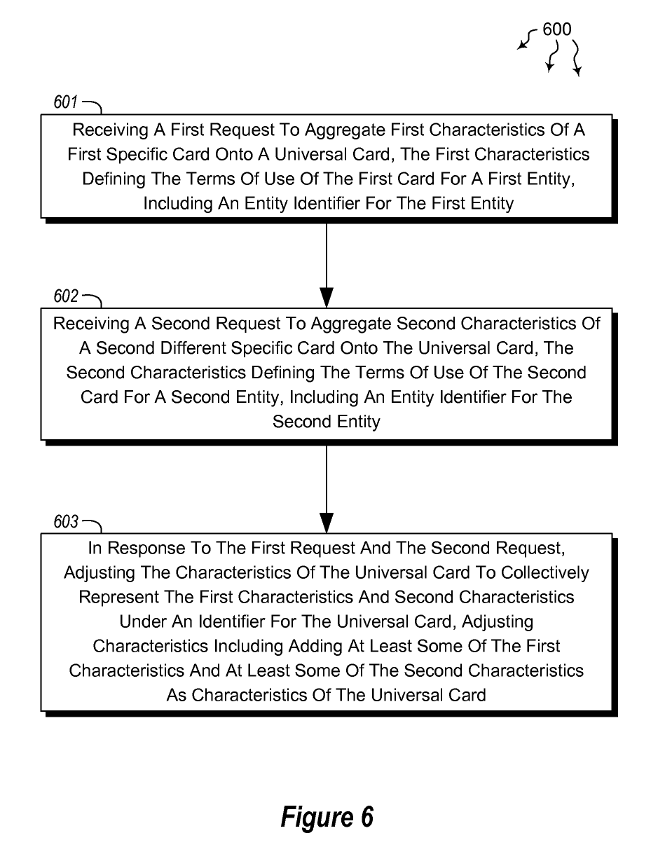

FIG. 6 illustrates a flow chart of an example method 600 for combining characteristics of different cards onto a universal card. Method 600 will be described with respect to the components and data in computer architecture 500.

Method 600 includes an act of receiving a first request to aggregate first characteristics of a first specified card onto a universal card, the first characteristics defining the terms of use of the first specified card for a first entity, including an entity identifier for the first entity (act 601). For example, universal card management system 506 can receive rewards card data 502 from user 501. Rewards card data 502 can be data corresponding to a physical rewards card of user 501. Rewards card data includes card identifier 503 and card characteristics 504. Card identifier 503 can indicate that rewards card data 502 is for a specified entity (e.g., merchant 527). Card characteristics 504 define terms of use of the rewards card represented by rewards card data 502. Card characteristics 504 can indicate one or more benefits conferred from the specified entity onto user 501, such as, for example, a discounts, points, mileage, etc.

Method 600 includes an act of receiving a second request to aggregate second characteristics of a second different specified card onto the universal card, the second characteristics defining the terms of use of the second specified card for a second entity, including an entity identifier for the second entity (act 602). For example, universal card management system 506 can receive rewards card data 532 from user 501. Rewards card data 532 can be data corresponding to a second physical rewards card of user 501. Rewards card data includes card identifier 533 and card characteristics 534. Card identifier 533 can indicate that rewards card data 532 is for a second specified entity (e.g., another merchant). Card characteristics 534 define terms of use of the rewards card represented by rewards card data 532. Card characteristics 534 can indicate one or more benefits conferred from the second specified entity onto user 501, such as, for example, discounts, points, mileage, etc.

Method 600 includes in response to the first request and the second request, an act of adjusting the characteristics of the universal card to collectively represent the first characteristics and second characteristics under an identifier for the universal card, adjusting characteristics including adding at least some of the first characteristics and at least some of the second characteristics as characteristics of the universal card (act 603). For example, characteristics adjustment module 542 can receive rewards card data 502 and rewards card data 532. In response to receiving rewards card data 502 and rewards card data 532, characteristics adjustment module 542 can adjust the characteristics of user card account 508 to collectively represent rewards card data 502 and rewards card data 532 under card ID 571. Adjusting the characteristics of user card account 508 can include adding rewards card data 502 and rewards card data 532 to characteristics 541. User card account 508 may also have universal gift card functionality such that balance 511 can be used at a specified group of merchants.

Subsequent to aggregation of rewards card data 502 and 532, merchant 527 can access card data for card 561 (. For example, card 561 can be swiped at merchant 527 to access encoded card ID 571 from within magnetic strip 562. Merchant 527 can then submit card ID 571 and merchant ID 579 to universal card management system 506. Merchant 527 may refer to card network 526 to determine that card ID 571 corresponds to universal card management system 506.

Universal card management system 506 can match the merchant data to user card account 508 based on card ID 571. Universal card management system 506 can also determine that card identifier 503 corresponds to merchant 527 based on merchant ID 579. In response, universal card management system 506 can return rewards card data 502 back to merchant 527. Merchant 527 can then provide any appropriate benefits to user 501 based on card data 502.

Similar actions can be used at other entities to access (e.g., rewards) card data stored within user card account 508.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, the computer system including a universal gift card management system, the computer system connected to a computer network, the universal gift card management system communicating with individuals and merchants via the computer network, at least some of the merchants included a group of participating merchants configured to accept funds linked to universal gift cards under the control of the universal gift card management system, a method for aggregating the balance of one or more merchant gift cards to the balance of a universal gift card for an individual, the method comprising:
an act of receiving a request to credit an individual's universal gift card from funds on a merchant gift card, the merchant gift card issued by a specified merchant and having a balance of a specified amount of funds, the specified amount of funds redeemable at the specified merchant;
in response to the request:
an act of the processor crediting a portion of the balance of funds on the merchant gift card to the individual's universal gift card, crediting the individual's universal gift card account making the portion of the balance of the merchant gift card available for use at any participating merchant; and
an act of transferring control of the merchant gift card to the universal gift card management system such that further use of the merchant gift card by other entities is prevented;
an act of the universal gift card management system participating in a transaction with the specified merchant to permit the specified merchant to buy back the merchant gift card form the universal gift card management system subsequent to transferring control of the merchant gift card to the universal gift card management system, including:
an act of transferring control of the merchant gift card back to the specified merchant; and
an act of receiving a further amount of funds from the specified merchant in exchange for transferring control of the merchant gift card back to the specified merchant.

2. The method as recited in claim 1, further comprising:
an act of receiving a request to credit the individual's universal gift card from funds on a second merchant gift card, the second merchant gift card issued by a second different specified merchant and having a balance of a second specified amount of funds, the second specified amount of funds redeemable at the second different specified merchant; and
in response to the request:
an act of the processor crediting a portion of the balance of the second merchant gift card to the individual's universal gift card, crediting the individual's universal gift card making the portion of the balance of the second merchant gift card available for use at any merchant included in the group of merchants; and
an act of transferring control of the second merchant gift card to the universal gift card management system such that further use of the second merchant gift card by other entities is prevented.

3. The method as recited in claim 2, further comprising an act of participating in a transaction with a merchant included in the group of merchants, including:
an act of the processor transferring an amount funds from the universal gift card to the merchant, the amount of funds including funds from both the first portion of the balance of the merchant gift card and the first portion of the balance of the second merchant gift card; and
an act of receiving an item from the merchant in response to transferring the amount of funds.

4. The method as recited in claim 1, wherein the first portion of the balance of the merchant gift card is less than the further amount of funds.

5. The method as recited in claim 1, wherein the act of crediting a first portion of the balance of the merchant gift card to the individual's universal gift card comprises an act of crediting the individual's universal gift card in essentially real-time using an electronic funds transfer.

6. The method as recited in claim 1, wherein the act of receiving a further amount of funds from the specified merchant comprises an act of receiving the further amount of funds in essentially real-time using an electronic funds transfer.

7. The method as recited in claim 1, further comprising an act of validating the request to credit an individual's universal gift card from funds on a merchant gift card according to security rules prior to processor crediting a first portion of the balance of the merchant gift card to the individual's universal gift card.

8. The method as recited in claim 1, where the act of an act of transferring control of the merchant gift card to the universal gift card management system comprises an act of referring to a gift card network to invalidate further use of the merchant gift card expect by the universal gift card management system.

9. At a computer system including one or more processors and system memory, the computer system including a universal gift card management system, the computer system connected to a computer network, the universal gift card management system communicating with individuals and merchants via the computer network, at least some of the merchants included a group of participating merchants configured to accept funds linked to universal gift cards under the control of the universal gift card management system, a method for managing terms of use for gift cards, the method comprising:
an act of receiving a request to credit an individual's universal gift card from funds on a merchant gift card, the merchant gift card issued by a specified merchant and having a balance of a specified amount of funds, the specified amount of funds redeemable at the specified merchant, the merchant gift card having one or more characteristics defining the terms of use of the merchant gift card;
in response to the request:
an act of crediting a first portion of the balance of the merchant gift card to the individual's universal gift card, crediting the individual's universal gift card making the first portion of the balance of the merchant gift card available for use at any participating merchant and
an act of transferring control of the merchant gift card to the universal gift card management system such that further use of the merchant gift card by other entities is prevented;
an act of the processor adjusting the one or more characteristics of the universal gift card based on the one or more characteristics of merchant gift card, including one or more of:
an act of ignoring a characteristic of the merchant gift card to remove a restriction on the terms of usage of the merchant gift card from the universal gift card; and
an act of adding a characteristic to the universal gift card to add a restriction the terms of use of the universal gift card; and
an act of participating in a transaction with the specified merchant to permit the specified merchant to buy back the merchant gift card subsequent transferring control of the merchant gift card to the universal gift card management system.

10. The method as recited in claim 9, wherein the act of ignoring a characteristic of the merchant gift card to remove a restriction on the terms of usage of the merchant gift card comprises an act of ignoring an expiration date on the merchant gift card to make the first portion of the balance of the merchant gift card available for use at the one or more merchants included in the group of merchants without an expiration date.

11. The method as recited in claim 9, wherein the act of adding a characteristic to the universal gift card to add a restriction to the terms of use of the universal gift card comprises an act of adding a characteristics to the universal gift card to block the universal gift card from use in purchasing one or more items based on identifier codes associated with the one or more items.

12. The method as recited in claim 11, wherein the act of adding a characteristics to the universal gift card to block the universal gift card from use in purchasing one or more items comprises an act of blocking the universal gift card from use in purchasing items having any of one or more specified universal product codes (“UPCs”).

13. The method as recited in claim 9, further comprising an act of validating the adjustment of the one or more characteristics of the universal gift card based on the one or more characteristics of merchant gift card according to security rules prior to adjusting the one or more characteristics of the universal gift card based on the one or more characteristics of merchant gift card.

14. At a computer system including one or more processors and system memory, the computer system including a universal gift card management system, the computer system connected to a computer network, the universal gift card management system communicating with individuals and merchants via the computer network, at least some of the merchants included a group of participating merchants configured to accept funds linked to universal gift cards under the control of the universal gift card management system, a method for crediting funds to the universal gift card management system, the method comprising:
an act of receiving a request to credit an individual's universal gift card by a specified amount of funds;
in response to the request:
an act of a the processor aggregating the specified amount of funds with current balance of the individual's universal gift card to credit the individual's universal gift card by the specified amount, crediting the individual's universal gift card making the specified amount of funds essentially immediately available for use at any merchant included in the group of merchants;
an act of the individual participating in a transaction with a specified merchant included in the group of merchants, including:
an act of receiving a request to transfer a second amount of funds from the individual's universal gift card to the specified merchant to purchase an item from the specified merchant;
an act of the processor transferring the second amount funds from the universal gift card to the specified merchant; and
an act of the individual receiving an item from the specified merchant in response to transferring the second amount of funds.

15. The method as recited in claim 14, wherein the act of receiving a request to credit an individual's universal gift card by a specified amount of funds comprises an act of receiving a request to transfer the specified amount of funds from another universal gift card to the individual's universal gift card.

16. The method as recited in claim 14, wherein the act of receiving a request to credit an individual's universal gift card by a specified amount of funds comprises an act of receiving an electronic funds transfer crediting the individual's universal gift card by the specified amount of funds.

17. The method as recited in claim 14, further comprising an act of validating the request to credit an individual's universal gift card by a specified amount of funds according to security rules prior to aggregating the specified amount of funds to current balance of the individual's universal gift card.

18. The method as recited in claim 14, further comprising:
an act of receiving a request to credit a second individual's universal gift card by a third specified amount of funds; and
in response to the request:
an act of the processor aggregating the third specified amount of funds to current balance of the second individual's universal gift card to credit the second individual's universal gift card by the third specified amount, crediting the second individual's universal gift card making the third specified amount of funds essentially immediately available for use at any merchant included in the group of merchants.

19. The method as recited in claim 18, further comprising:
act of receiving requests to credit an one or more additional universal gift cards by corresponding additional specified amounts of funds; and
in response to the requests:
an act of a the processor aggregating the additional specified amounts of funds to current balances of the one or more additional universal gift cards to credit the one or more universal gift cards by the additional amounts.

20. The method as recited in claim 19, further comprising:
an act of calculating an amount of unused balances across a plurality of universal gift cards within the universal gift card management system;
an act of transferring a portion of the amount of unused balances into an interest bearing account for the benefit of at least one of the universal gift card management system and one or more participating merchants;
an act of receiving the portion of the amount of unused balances plus an additional amount of funds from the interest bearing account subsequent to transferring the portion of the amount of unused balances into the interest bearing account; and
an act of maintaining the additional amount of funds in an account for the benefit of at least one of the universal gift card management system and the one or more participating merchants.

21. At a computer system including one or more processors and system memory, the computer system including a universal card management system, the computer system connected to a computer network, the universal card management system communicating with individuals and merchants via the computer network, a method for managing characteristics associated with a universal card, the method comprising:
an act of receiving a first request to aggregate first characteristics of a first specified card onto a universal card, the first characteristics defining the terms of use of the first specified card for a first entity, including an entity identifier for the first entity;
an act of receiving a second request to aggregate second characteristics of a second different specified card onto the universal card, the second characteristics defining the terms of use of the second specified card for a second entity, including an entity identifier for the second entity; and
in response to the first request and the second request, an act of adjusting the characteristics of the universal card to collectively represent the first characteristics and second characteristics under an identifier for the universal card, adjusting characteristics including adding at least some of the first characteristics and at least some of the second characteristics as characteristics of the universal card.

22. The method as recited in claim 21, wherein the first specific card is one of a rewards card, a membership card, a savings card, a club card, a preferred card, a mileage card, a loyalty card, a V.I.P. card, a discount card, a coupon card, an activity card, an I.D., a season pass, an annual pass, and a program pass.

23. The method as recited in claim 21 further comprising:
an act of receiving a request for any benefits associated with a specified universal card from a requestor, the request indicating that of the specified universal card has been presented for use in a transaction, the request including a card ID and a merchant ID;
an act of determining that the request is for benefits associated with the universal card by matching the received card ID to the identifier for the universal card;
an act of determining that the associated benefits relate to the first entity by matching the merchant ID with the entity identifier for the first entity within the characteristics for the universal card; and
an act of returning card data for the first specified card to the requestor in response to the request, the returned card data permitting the requestor to determine benefits corresponding to the transaction.

24. The method as recited in claim 23, wherein the act of receiving a request comprises an act of receiving a request from the first entity, wherein the first entity is a merchant; and
wherein the act of returning card data for the first specified card to the requestor comprises an act of returning card data the first characteristics to the merchant so that the merchant can determine any benefits corresponding to the transaction from the first characteristics.
